(19) United States
(12) Patent Application Publication
(10) Pub. No.: US 2020/0080477 A1
(43) Pub. Date: Mar. 12, 2020

(54) PREDICTION OF INLET DISTORTION OF BOUNDARY LAYER INGESTING PROPULSION SYSTEM

(71) Applicant: United Technologies Corporation, Farmington, CT (US)

(72) Inventor: Michael Joseph Murphy, Windsor, CT (US)

(21) Appl. No.: 16/124,506

(22) Filed: Sep. 7, 2018

(51) Int. Cl. F02C 7/057; B64D 33/02; B64D 29/04; B64D 27/20; F02C 9/22; F02K 3/06

(52) U.S. Cl. CPC F02C 7/057; B64D 33/02; B64D 29/04; B64D 2033/0286; F02C 9/22; F02K 3/06; B64D 2033/0226; B64D 27/20

(57) ABSTRACT

A gas turbine engine assembly according to an exemplary embodiment of this disclosure includes, among other possible things, a plurality of fan blades rotatable about a fan rotation axis; a fan nacelle at least partially surrounding the plurality of fan blades, the fan nacelle defining an inlet; at least one sensor positioned forward of the fan nacelle, the at least one sensor generating a signal indicative of an airflow condition entering the inlet; an effector that is actuatable to accommodate distortions in inlet airflow; and a controller receiving the signal from the at least one sensor and determining an inlet distortion condition corresponding to the signal indicative of an airflow condition and actuating the effector based on the identified inlet distortion condition.

### BACKGROUND

Conventional aircraft architecture includes wing mounted gas turbine engines. Alternate aircraft architectures mount the gas turbine engines atop the fuselage or on opposite sides of the aircraft fuselage adjacent to a surface. Accordingly, a portion of an engine fan may ingest portions of a boundary layer of airflow while other portions of the fan spaced apart from the aircraft surface may not encounter boundary layer flow. Differences in airflow characteristics across different parts of the fan can impact fan efficiency.

### SUMMARY

A gas turbine engine assembly according to an exemplary embodiment of this disclosure includes, among other possible things, a plurality of fan blades rotatable about a fan rotation axis; a fan nacelle at least partially surrounding the plurality of fan blades, the fan nacelle defining an inlet; at least one sensor positioned forward of the fan nacelle, the at least one sensor generating a signal indicative of an airflow condition entering the inlet; an effector that is actuatable to accommodate distortions in inlet airflow; and a controller receiving the signal from the at least one sensor and determining an inlet distortion condition corresponding to the signal indicative of an airflow condition and actuating the effector based on the identified inlet distortion condition.

In a further embodiment of the foregoing gas turbine engine assembly, the signal indicative of an airflow condition generated by the at least one sensor comprises a non-uniform airflow condition.

In a further embodiment of any of the foregoing gas turbine engine assemblies, a portion of the fan nacelle is disposed adjacent a forward surface that is forward of the inlet and the at least one sensor is disposed on the forward surface forward of the inlet.

In a further embodiment of any of the foregoing gas turbine engine assemblies, the fan nacelle is integrated into an aircraft structure and the forward surface is a portion of the aircraft structure.

In a further embodiment of any of the foregoing gas turbine engine assemblies, the fan nacelle includes a top surface spaced apart from the forward surface in a direction transverse to the fan rotation axis and a second sensor is disposed on the top surface.

In a further embodiment of any of the foregoing gas turbine engine assemblies, the at least one sensor includes a plurality of sensors spaced apart forward of the inlet.

In a further embodiment of any of the foregoing gas turbine engine assemblies, the plurality of sensors are spaced axially apart from each other forward of the inlet.

In a further embodiment of any of the foregoing gas turbine engine assemblies, the at least one sensor comprises a pressure probe.

In a further embodiment of any of the foregoing gas turbine engines assemblies, the effector comprises a pitch control mechanism that changes a pitch of each of the fan blades to accommodate the determined inlet distortion condition.

In a further embodiment of any of the foregoing gas turbine engine assemblies, the effector comprises mechanism that changes an incident angle of each of the plurality of fan blades based on a circumferential position.

Another gas turbine engine assembly according to an exemplary embodiment of this disclosure includes, among other possible things, a plurality of fan blades rotatable about a fan rotation axis; a fan nacelle at least partially surrounding the plurality of fan blades, the fan nacelle defining an inlet; at least one means of generating a signal indicative of an airflow condition entering the inlet; an effector that is actuatable to accommodate distortions in inlet airflow; and a controller receiving a signal indicative of an airflow condition entering the inlet and determining an inlet distortion condition corresponding to the signal indicative of an airflow condition and actuating the effector based on the identified inlet distortion condition.

In a further embodiment of the foregoing gas turbine engine assembly, the signal indicative of an airflow condition comprises a non-uniform airflow condition about the inlet.

In another embodiment of any of the foregoing gas turbine engine assemblies, a portion of the fan nacelle is disposed adjacent a forward surface that is forward of the inlet and the at least one means for generating a signal is disposed on the forward surface forward of the inlet.

A method of operating a gas turbine engine mounted within an aircraft fuselage according to an exemplary embodiment of this disclosure includes, among other possible things, measuring a pressure forward of an inlet of a fan nacelle with at least one sensor disposed on a surface forward of the fan inlet; determining an inlet distortion condition based on the measured pressure; and actuating an effector to change an engine operational parameter based on the determined inlet distortion condition.

In a further embodiment of the foregoing method of operating a gas turbine engine mounted within an aircraft fuselage, the fan nacelle is integrated into an aircraft fuselage and partially surrounds a plurality of fan blades rotatable about a fan axis and the surface forward of the fan inlet is a portion of the aircraft fuselage.

In a further embodiment of any of the foregoing methods of operating a gas turbine engine mounted within an aircraft fuselage, at least a portion of airflow into the fan inlet is a boundary layer along the forward surface of the aircraft fuselage and the inlet distortion varies in a direction away from the forward surface.

In a further embodiment of any of the foregoing methods of operating a gas turbine engine mounted within an aircraft fuselage, a plurality of pressures is identified that correspond with one of a plurality of inlet distortion conditions and determining the inlet distortion condition based on the pressure measured by the at least one sensor forward of the inlet.

In a further embodiment of any of the foregoing methods of operating a gas turbine engine mounted within an aircraft fuselage, the plurality of inlet distortion conditions comprise an airflow velocity profile that varies in a direction transverse to the fan axis.

In a further embodiment of any of the foregoing methods of operating a gas turbine engine mounted within an aircraft fuselage, the at least one sensor comprise a plurality of pressure sensors spaced axially forward of the fan inlet that measure a static pressure.

In a further embodiment of any of the foregoing methods of operating a gas turbine engine mounted within an aircraft fuselage, an effector is actuated to change an engine operational parameter based on the determined inlet distortion condition by changing a pitch angle for each of a plurality of fan blades rotating into a low airflow velocity region during rotation about a rotational axis, and changing the pitch angle for each of the plurality of fan blades rotating into a higher airflow velocity region during rotation about the rotational axis.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example aircraft.

FIG. 2 is a schematic view of a portion of the example aircraft and an example propulsion system.

FIG. 3 is a schematic representation of an incoming airflow velocities.

FIG. 4 is a schematic view of the example propulsion system embodiment.

FIG. 5 is a flow chart illustrating a process of defining operation of the example propulsion system.

### DETAILED DESCRIPTION

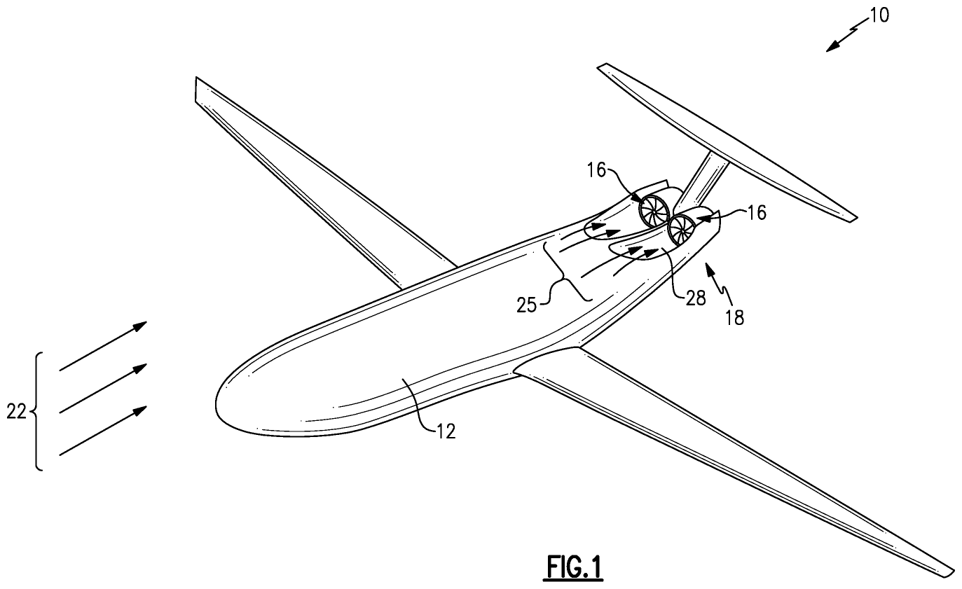

Referring to the FIG. 1, an aircraft 10 includes a fuselage 12 and a propulsion system 18 mounted within an aft end of the fuselage 12. The example propulsion system 18 includes first and second gas turbine engines (not shown) that drive corresponding fan assemblies 16.

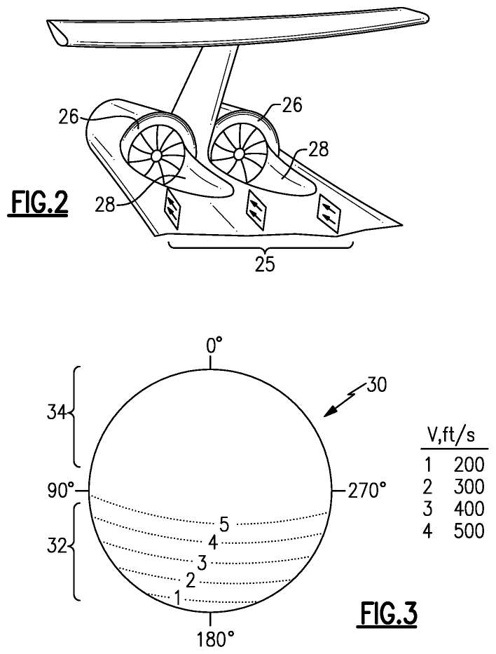

Referring to FIG. 2 with continued reference to FIG. 1, the propulsion system 18 ingests airflow through each fan assembly 16. Because the propulsion system 18 is mounted at the aft end of the fuselage 12, the fan assemblies 16 ingest boundary layer airflow schematically shown at 25. Each fan assembly 16 is partially surrounded by a nacelle 26. A portion of the fan assembly 16 not surrounded by the nacelle 26 is disposed aft of a surface 28 of the fuselage 12. Due to boundary layer development along fuselage 12 and surface 28, airflow 25 along and above surface 28 that enters the fan assemblies 16 is non-uniform. In this example, a velocity of the airflow 25 varies in a direction transverse to the fan rotational axis away from the surface 28. The uniform flow schematically shown at 22 that initially is encountered by the aircraft is changed by the proximity to the fuselage 12 and surface by boundary layer effects. The varying airflow velocity creates a non-uniform flow-field entering the fan assembly 16 that results in non-optimal incidence angles for at least some of the fan blades 20 during a portion of rotation. Conventional jet engine fans are designed to receive uniform flow for each circumferential position.

The pitch angle for each fan blade 20 is conventionally the same for fan assemblies 16 not subject to non-uniform airflow velocities. As appreciated, in a conventional nacelle mounted engine, the flow field is substantially uniform and therefore a single blade pitch angle for each fan blade can be utilized and optimized.

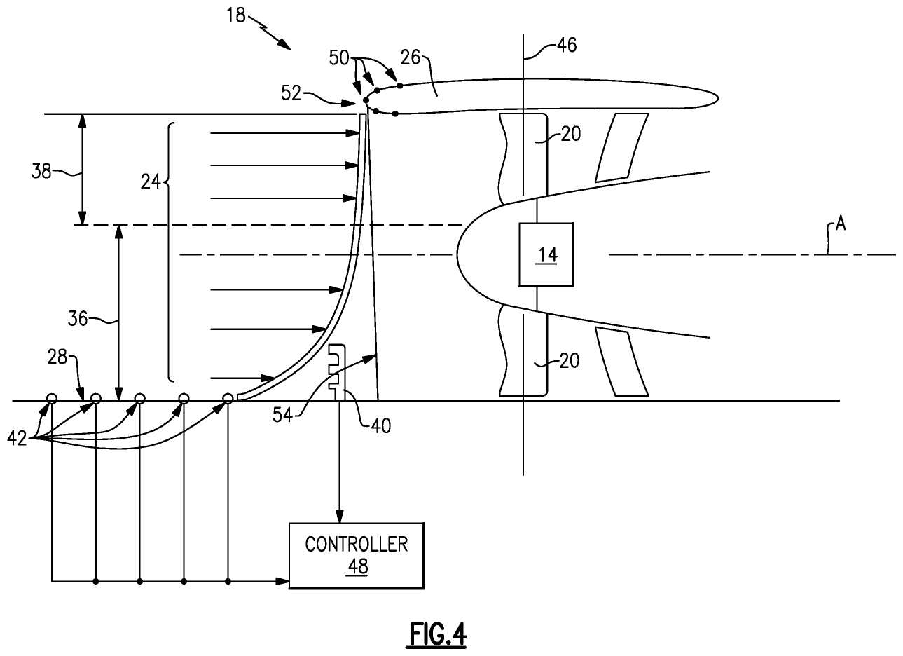

Referring to FIG. 3, with continued reference to FIGS. 1 and 2, a representation of airflow velocities within different regions of the circumference of the disclosed example fan assembly 16 is indicated at 30. The example airflow velocities are shown as examples and other velocity profiles and values may be applicable depending on fuselage shape configuration and the generation of the boundary layer airflow. The represented airflow velocities 30 illustrate differences in airflow velocities relative to the different regions within the circumference of the fan 16.

The example fan assemblies 16 are mounted adjacent to surfaces 28 of the fuselage 12 and therefore encounter non-uniform airflow velocities that vary within a circumferential region of a fan inlet area. The airflow velocities vary in a way that corresponds with a distance from the surface 28 of the fuselage 12. The closer to the surface 28, the slower the airflow. The further away from the surface 28, the higher the airflow velocity. The non-uniform airflow velocities create different regions including a lower velocity region schematically shown at 32 and a higher velocity region 34. The differences in inlet airflow velocities result in differing output velocities of airflow and a varying inlet distortion condition.

Referring to FIG. 4, with continued reference to FIGS. 2 and 3, the example propulsion system 18 includes features that detect an airflow condition entering a fan inlet 54 and adjusts operation to accommodate the detected airflow condition. In this example, the airflow condition is the varying airflow velocity that is schematically indicated at 24. A controller 48 commands an effector 14 that adjusts engine features to accommodate the varying airflow velocities. In this example, the effector 14 is a mechanism that adjusts a pitch of each of the fan blades 20 based on a circumferential position to accommodate for the differing airflow velocity regions. It should be understood, that other effector 14 structures could be utilized to accommodate the differing airflow velocity regions including variable stators, variable nozzles, boundary layer removal devices along with other structures that compensate for the non-uniform airflow.

A plurality of sensors 42 are disposed on the surface 28 forward of a fan inlet 54 of fan nacelle 26 and are utilized to identify the inlet distortion condition to guide operation of the effector 14. In this example, the sensors 42 are pressure sensors that sense a static pressure at various points spaced axially forward of the fan inlet 54 and fan blades 20. The sensors 42 communicate the static pressure to the controller 48. The controller 48 uses information from the sensors 42 to determine the inlet airflow condition and adjusts the effector 14 accordingly.

Additional sensors 50 and 40 can be utilized instead, or in combination with the sensors 42. The sensor 40 senses a total pressure at a location forward of the inlet 54. The sensors 50 are mounted at a tip 52 of the nacelle 26 and provide information indicative of a static or total pressure at a location spaced apart from the surface 28 and the boundary layer airflow. The sensors, 40, 42 and 50 maybe of any known sensor configuration that provide information indicative of a pressure at the mounted location. The sensors 40, 42 and 50 are utilized to sense a pressure in order to determine an airflow condition at the inlet 54. It should be appreciated that although pressure sensors are disclosed by way of example, other sensing devices that can provide information usable to determine an airflow condition at the inlet could also be utilized and are within the contemplation of this disclosure.

In this example disclosed embodiment, the effector 14 adjusts a pitch of each of the fan blades 20 during each rotation about the axis A. The pitch of each fan blades 20 is thereby changed during operation depending on the circumferential position that corresponds with the different airflow velocity regions 36, 38. The pitch of each blade 20 is therefore adjusted throughout each rotation about the axis A to provide the most efficient orientation for the given region 36, 38. It should be appreciated that although two regions are shown by way of example, multiple regions could be included to further optimize fan operation and are within the contemplation and scope of this disclosure.

In this disclosed example, the inlet distortion comprises the varying airflow velocity field generally indicated at 24 that changes in a direction radially away from the surface 28. In this example, the velocities decrease in a direction towards the surface 28. In other words, the boundary layer that is flowing along the surface 28 is much slower than the airflow spaced apart from the surface 28. The differing airflows create an inlet distortion condition that is compensated by adjustments to structures of the propulsion system 18 actuated by the example effector 14.

It is understood that airflow changes during aircraft operation depending on environmental and operational conditions. The example propulsion system 18 utilizes the sensors 40, 42, 50 to measure a parameter that is correlated to a predetermined inlet distortion condition recognized by the controller 48. Upon identification of the inlet distortion condition that corresponds with the measured parameter, the effector 14 is actuated to adjust operation accordingly.

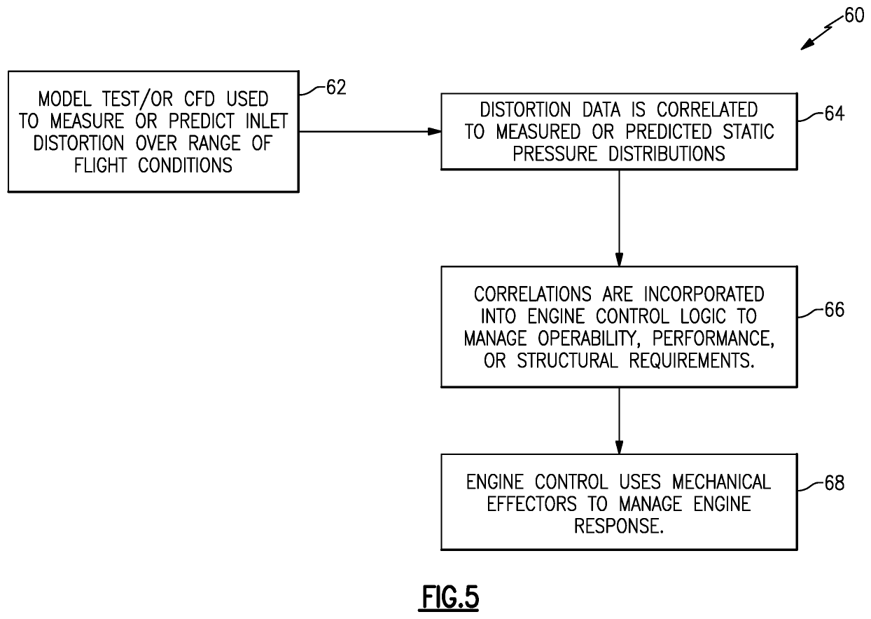

Referring to FIG. 5, with continued reference to FIG. 4, a method of determining operational parameters of a gas turbine engine is schematically indicated at 60. The example disclosed method identifies differing inlet distortion conditions and determines values of operating parameters that can be measured by the sensors 40, 42, 50 that correspond with each different inlet distortion condition. Accordingly, an initial step indicated at 62 is performed to provide information utilized by the controller 48 to command the effector 14. A plurality of differing inlet distortion conditions are tested and pressure readings at the location of the sensors 40, 42 and 50 are recorded.

The inlet distortion conditions can be replicated using a test model or through computational fluid dynamic analysis techniques. Moreover, other techniques could be utilized to generate information that correlates a measurable operating parameter with an inlet distortion condition. A correlation between the inlet distortion conditions and the measurable data is determined as is indicated at 64. In this disclosed example, each inlet distortion condition is correlated to a static pressure and/or total pressure measurable by the sensors 40, 42 and 50. The correlation information is provided to the controller 48 and utilized to manage operability, performance and adjustments to structural features of the propulsion system 18. For each identified inlet distortion condition, a correlated static and/or total pressure is also identified. An adjustment of the effector 14 that provides the most efficient operation for the identified inlet distortion condition is also identified and accessible by the controller 48 as is indicated at 66. The controller 48 can be a part of the aircraft 10 full authority digital control (FADEC) or other aircraft or propulsion system controller.

During operation, the controller 48, receives information from the sensors 40, 42 and 50 indicative of pressures at various locations near the inlet 54. The information regarding the various pressures is identified and matched to a corresponding predefined inlet distortion condition. In the disclosed example, the inlet distortion condition is a non-uniform airflow velocity as shown in FIG. 4 that varies between the surface 28 and the nacelle tip 52. The specific distribution of airflow velocities may change during an operational cycle of the aircraft. Each different airflow velocity distribution will have a different and corresponding pressures that are measured by the sensors 40, 42, 50.

The controller 48 recognizes the different inlet distortion conditions by the constant information provided by the sensors 40, 42 and 50. The controller 48 correlates the measured pressure to a predefined inlet distortion condition and actuates the effector 14 to provide a predefined configuration that increases efficiency. In this example, the effector 14 changes the pitch of each fan blade 20 based on a circumferential position. The circumferential position and pitch of each fan blade 20 is thereby adjusted based on the detected inlet distortion condition. Accordingly, the direct reading of pressures is used to identify an inlet distortion condition and the effector 14 tailors operation of the propulsion system in view of the identified inlet distortion condition.

Accordingly, the example system provides a method and means of accommodating non-uniform inlet distortions created by boundary layer ingestion for propulsors that are disposed within an aircraft fuselage.

Although an example embodiment has been disclosed, a worker of ordinary skill in this art would recognize that this disclosure is not just a material specification and that certain modifications would come within the scope of this disclosure. For that reason, the following claims should be studied to determine the scope and content of this disclosure.

What is claimed is:

1. A gas turbine engine assembly comprising;
a plurality of fan blades rotatable about a fan rotation axis;
a fan nacelle at least partially surrounding the plurality of fan blades, the fan nacelle defining an inlet;
at least one sensor positioned forward of the fan nacelle, the at least one sensor generating a signal indicative of an airflow condition entering the inlet;
an effector that is actuatable to accommodate distortions in inlet airflow; and
a controller receiving the signal from the at least one sensor and determining an inlet distortion condition corresponding to the signal indicative of an airflow condition and actuating the effector based on the identified inlet distortion condition.

2. The gas turbine engine assembly as recited in claim 1, wherein the signal indicative of an airflow condition generated by the at least one sensor comprises a non-uniform airflow condition.

3. The gas turbine engine assembly as recited in claim 1, wherein a portion of the fan nacelle is disposed adjacent a forward surface that is forward of the inlet and the at least one sensor is disposed on the forward surface forward of the inlet.

4. The gas turbine engine assembly as recited in claim 3, wherein the fan nacelle is integrated into an aircraft structure and the forward surface is a portion of the aircraft structure.

5. The gas turbine engine assembly as recited in claim 3, wherein the fan nacelle includes a top surface spaced apart from the forward surface in a direction transverse to the fan rotation axis and a second sensor is disposed on the top surface.

6. The gas turbine engine assembly as recited in claim 1, wherein the at least one sensor includes a plurality of sensors spaced apart forward of the inlet.

7. The gas turbine engine assembly as recited in claim 6, wherein the plurality of sensors are spaced axially apart from each other forward of the inlet.

8. The turbine engine assembly as recited in claim 1, wherein the at least one sensor comprises a pressure probe.

9. The turbine engine assembly as recited in claim 1, wherein the effector comprises a pitch control mechanism that changes a pitch of each of the fan blades to accommodate the determined inlet distortion condition.

10. The turbine engine assembly as recited in claim 1, wherein the effector comprises mechanism that changes an incident angle of each of the plurality of fan blades based on a circumferential position.

11. A gas turbine engine assembly comprising;
a plurality of fan blades rotatable about a fan rotation axis;
a fan nacelle at least partially surrounding the plurality of fan blades, the fan nacelle defining an inlet;
at least one means of generating a signal indicative of an airflow condition entering the inlet;
an effector that is actuatable to accommodate distortions in inlet airflow; and
a controller receiving a signal indicative of an airflow condition entering the inlet and determining an inlet distortion condition corresponding to the signal indicative of an airflow condition and actuating the effector based on the identified inlet distortion condition.

12. The gas turbine engine assembly as recited in claim 11, wherein the signal indicative of an airflow condition comprises a non-uniform airflow condition about the inlet.

13. The gas turbine engine assembly as recited in claim 11, wherein a portion of the fan nacelle is disposed adjacent a forward surface that is forward of the inlet and the at least one means for generating a signal is disposed on the forward surface forward of the inlet.

14. A method of operating a gas turbine engine mounted within an aircraft fuselage, the method comprising:
measuring a pressure forward of an inlet of a fan nacelle with at least one sensor disposed on a surface forward of the fan inlet;
determining an inlet distortion condition based on the measured pressure; and
actuating an effector to change an engine operational parameter based on the determined inlet distortion condition.

15. The method as recited in claim 14, wherein the fan nacelle is integrated into an aircraft fuselage and partially surrounds a plurality of fan blades rotatable about a fan axis and the surface forward of the fan inlet is a portion of the aircraft fuselage.

16. The method as recited in claim 15, wherein at least a portion of airflow into the fan inlet is a boundary layer along the forward surface of the aircraft fuselage and the inlet distortion varies in a direction away from the forward surface.

17. The method as recited in claim 15, including identifying a plurality of pressures that correspond with one of a plurality of inlet distortion conditions and determining the inlet distortion condition based on the pressure measured by the at least one sensor forward of the inlet.

18. The method as recited in claim 17, wherein the plurality of inlet distortion conditions comprise an airflow velocity profile that varies in a direction transverse to the fan axis.

19. The method as recited in claim 14, wherein the at least one sensor comprise a plurality of pressure sensors spaced axially forward of the fan inlet that measure a static pressure.

20. The method as recited in claim 14, wherein actuating an effector to change an engine operational parameter based on the determined inlet distortion condition comprises changing a pitch angle for each of a plurality of fan blades rotating into a low airflow velocity region during rotation about a rotational axis and changing the pitch angle for each of the plurality of fan blades rotating into a higher airflow velocity region during rotation about the rotational axis.
